(19) United States
(12) Patent Application Publication
(10) Pub. No.: US 2011/0207505 A1
(43) Pub. Date: Aug. 25, 2011

(54) METHOD AND APPARATUS FOR PREVENTING FLICKER PHENOMENON ON DISPLAY OF MOBILE TERMINAL

(75) Inventor: Kyung Hoon YOON, Suwon-si (KR)

(73) Assignee: SAMSUNG ELECTRONICS CO. LTD., Suwon-si (KR)

(21) Appl. No.: 13/022,998

(22) Filed: Feb. 8, 2011

(30) Foreign Application Priority Data
Feb. 24, 2010 (KR) 10-2010-0016649

(51) Int. Cl. H04W 88/02

(52) U.S. Cl. 455/556.1

(57) ABSTRACT

A method and apparatus for suppressing screen flicker phenomenon resulting from differences between a scanning frequency of a camera module and a mains power frequency of the region where the mobile terminal is located are provided. The method includes acquiring, when a camera module of the mobile terminal is activated, location information of the mobile terminal, determining a power frequency mapped to the location information, and matching a scanning frequency of the camera module to the power frequency.

### PRIORITY

This application claims the benefit under 35 U.S.C. §119(a) of a Korean patent application filed on Feb. 24, 2010 in the Korean Intellectual Property Office and assigned Serial No. 10-2010-0016649, the entire disclosure of which is hereby incorporated by reference.

### BACKGROUND OF THE INVENTION

1. Field of the Invention

The present invention relates to flicker phenomenon prevention during imaging detection in a mobile terminal. More particularly, the present invention relates to a method and apparatus for preventing screen flicker phenomenon resulting from different frequencies between a scanning frequency of a camera module and a mains power frequency of a region where the mobile terminal is located.

2. Description of the Related Art

With recent developments in communication and semi-conductor technologies, the use of mobile communication terminals has rapidly increased. More particularly, recent trend for mobile terminals is the convergence of the functions of traditional mobile terminals as well as functions of other types of devices. Typically, the recent mobile terminals are provided with various supplementary functions including broadcast playback function for supporting Digital Multimedia Broadcasting (DMB) or Digital Video Broadcasting (DVB), an audio file player such as a Moving Picture Experts Group (MPEG)-1 or MPEG-2 Audio Layer-3 (MP3) player, a camera function, an Internet access function, and the like. More particularly, as the mobile terminal is equipped with a camera module, picture related functions are being reinforced.

Typically, the camera module of a mobile terminal is implemented using a semiconductor device which converts an optical signal into an electrical signal. The light source for the camera can be classified into sun light and artificial lights, and the artificial lights can be classified into fluorescent light and incandescent light.

The frequencies of AC voltages for use in the fluorescent light are different based on geographical regions, such as countries. Also, based on a country, there are three video standards, for power frequency such as a National Television System Committee (NTSC) standard, a Phase Alternation Line (PAL) standard, and a Sequential Color Memory (SECAM) standard. North America uses a 60 Hz power frequency NTSC standard, Europe uses a 50 Hz power frequency PAL standard, and Japan use both the 60 Hz power frequency NTSC standard and the 50 Hz power frequency PAL standard.

Unlike the case when taking a picture with the camera module under the sunlight or the incandescent light, the user is likely to experience flicker noise such as curved stripes on a screen when trying to take a picture under a fluorescent light. The flicker noise occurs due to differences between a scanning frequency of the camera module and a mains power frequency at which the fluorescent lamp operates.

That is, the flicker phenomenon occurs when the scanning frequency of the camera module differs from the mains power frequency of the country (or region) where the mobile terminal is located. For example, when trying to take a picture with a camera set to operate at the scanning frequency of 60 Hz in the region using the mains power frequency of 50 Hz or with a camera set to operate at 50 Hz in the region using 60 Hz, the flicker phenomenon occurs on the screen of the mobile terminal.

Most mobile terminals are provided with a means for matching the scanning frequency to a regional mains power frequency in order to suppress the flicker noise. More particularly, in a country, such as Japan, which is divided into regions using two different mains power frequencies, most of the mobile terminals are designed to provide a menu option for the user to set the scanning frequency of the camera module to the regional mains power frequencies to prevent the flicker noise. That is, the user residing in the region using the mains power frequency of 50 Hz sets, by means of a menu setting, the scanning frequency of the mobile terminal to 50 Hz, whereas the user residing in the region using the mains power frequency of 60 Hz sets the scanning frequency of the camera module of the mobile terminal to 60 Hz.

However, the above-described conventional mobile terminal has a drawback in that, although the scanning frequency setting menu is provided, it is not easy for the user, who is traveling out of a home region, to determine the mains power frequency of every traveling region. If the mains power frequency of the region is known, it is a cumbersome task to manipulate a scanning frequency setting menu whenever crossing borders of regions using different mains power frequencies.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for automatically suppressing screen flicker phenomenon resulting from different frequencies between a camera scanning frequency and a mains power frequency.

Another aspect of the present invention is to provide a mobile terminal and a method for suppressing flicker phenomenon, in the mobile terminal equipped with a camera module, resulting from different frequencies between a camera scanning frequency and a mains power frequency using location information of the mobile terminal.

Still another aspect of the present invention is to provide a mobile terminal and a method for controlling the mobile terminal that is capable of registering mains power frequencies of individual geographical regions and matching, based on the location information of the mobile terminal, the scanning frequency of the camera module to the mains power frequency of the region where the mobile terminal is located, resulting in suppressing flicker phenomenon.

A further aspect of the present invention is to provide a mobile terminal and a method for controlling the mobile terminal that is capable of matching, based on the location information of the mobile terminal, the scanning frequency of the camera module of the mobile terminal to mains power frequency of the region where the mobile terminal is located, resulting in improvement of device usability and user convenience.

In accordance with an aspect of the present invention, a method for suppressing screen flicker phenomenon in a mobile terminal is provided. The method includes acquiring, when a camera module of the mobile terminal is activated, location information of the mobile terminal, determining a power frequency mapped to the location information, and matching a scanning frequency of the camera module to the power frequency.

In accordance with another aspect of the present invention, a mobile terminal is provided. The terminal includes a camera module for taking a picture, a display unit for displaying preview data input through the camera module, a location information generator for acquiring location information of the mobile terminal, a storage unit for storing a mapping table including mapping information between location information and power frequencies, and a control unit for acquiring current location information when the camera module is activated and for matching a scanning frequency of the camera module to a power frequency mapped to the current location information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile terminal according to an exemplary embodiment of the present invention;

FIG. 2 is a flowchart illustrating a mains power frequency registration procedure of a flicker phenomenon suppression method for a mobile terminal according to an exemplary embodiment of the present invention;

FIG. 3 is a flowchart illustrating a frequency matching procedure of a flicker phenomenon suppression method for a mobile terminal according to an exemplary embodiment of the present invention; and

FIG. 4 is a flowchart illustrating a frequency matching procedure of a flicker phenomenon suppression method for a mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, description of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide an apparatus and method for suppressing screen flicker phenomenon resulting from different frequencies between a camera scanning frequency of the mobile terminal and a mains power frequency of artificial light in a current region. According to an exemplary embodiment of the present invention, the mains power frequencies of the regions are registered with the mobile terminal in advance. When the camera module is activated, the mobile terminal automatically acquires its location information and automatically matches the camera scanning frequency to the mains power frequency of an artificial light in the current region based on the location information. As the camera scanning frequency is automatically matched to the mains power frequency of the artificial light when the camera module of the mobile terminal is activated, it is possible to prevent screen flicker. That is, a method and apparatus according to an exemplary embodiment of the present invention is capable of suppressing the screen flicker by matching the camera scanning frequency of the camera module with the mains power frequency of the current region based on the location information of the mobile terminal.

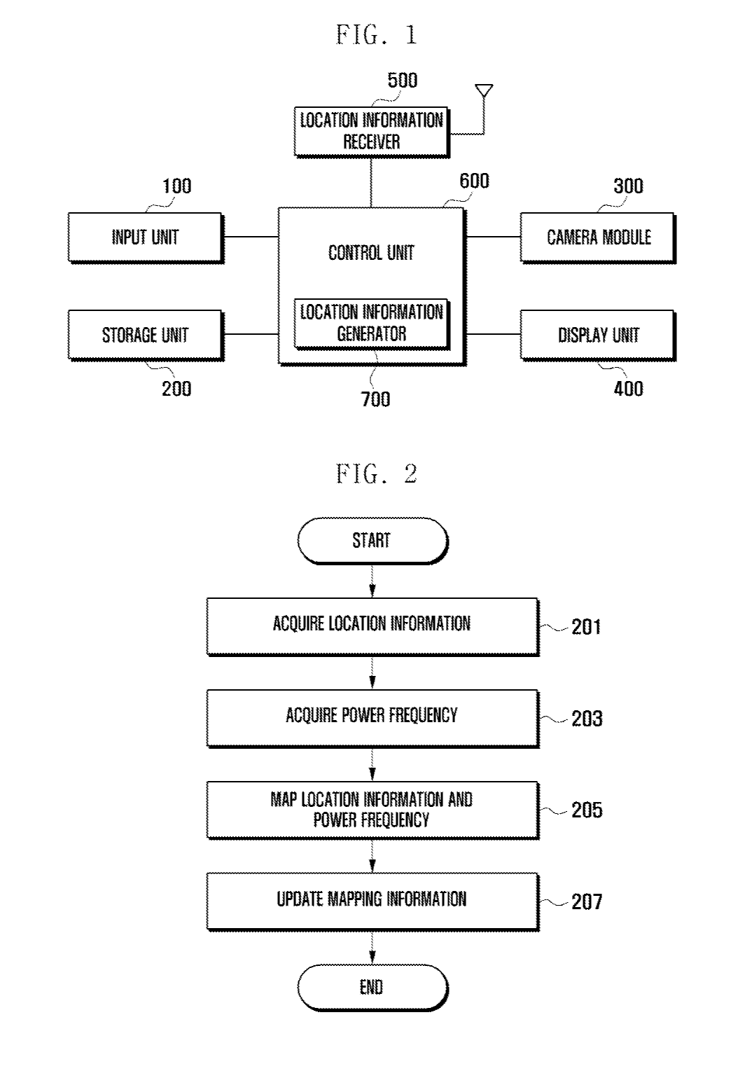

The configuration of the mobile terminal and control method thereof is described below with reference to FIGS. 1 to 4. The configuration of the mobile terminal and control method of the mobile terminal are not limited to the following description, but various modifications and changes may be made without deviation of the scope and focus of the present invention.

FIG. 1 is a block diagram illustrating a configuration of a mobile terminal according to an exemplary embodiment of the present invention.

Referring to FIG. 1, the mobile terminal includes an input unit 100, a storage unit 200, a camera module 300, a display unit 400, a location information receiver 500, and a control unit 600. The control unit 600 includes a location information generator 700. Although not illustrated, the mobile terminal may further include supplementary function modules, such as a Radio Frequency (RF) unit, an audio processing unit having a microphone (MIC) and a speaker (SPK), a digital broadcast module for receiving and playing digital broadcast such as Digital Multimedia Broadcasting (DMB) and Digital Video Broadcasting (DVB), a Bluetooth module for supporting Bluetooth communication, an Internet access module for supporting Internet access, and the like. The above-described supplementary function modules are well known to those skilled in the art, thus detailed descriptions thereof are omitted.

The input unit 100 detects a user input and generates the input signal corresponding to the user input. The input unit 100 may include a plurality of buttons. More particularly, the input unit 100 may include one or more buttons for generating input signals for activating the camera module 300 and setting a mains power frequency of a current location.

The storage unit 200 stores data and various application programs running in the mobile terminal and includes at least one of a volatile memory device and a nonvolatile memory device. For example, the storage unit 200 may permanently or temporarily store an Operating System (OS) of the mobile terminal, application programs and data related to control of the camera module 300, application programs and data related to control of the display unit 400, and application programs and data related to automatic power frequency settings. The storage unit 200 may permanently or temporarily include storage regions for storing the mains power frequencies of the geographical regions in the form of a mapping table.

The camera module 300 takes a picture of an object and transfers video data corresponding to the picture to the display unit 400 and the control unit 600 under the control of the control unit 600. The camera module 300 converts the light input (i.e., an optical signal) through a camera lens into digital data by means of a sensor. The camera module 300 may include a camera sensor (not illustrated) for converting the input optical signal into an electrical signal and a signal processor for converting the electrical signal input from the camera sensor into a digital signal. The camera sensor may be implemented with a Charge-Coupled Device (CCD) or a Complementary Metal-Oxide-Semiconductor (CMOS). More particularly, the camera module 300 can take pictures with the power frequency automatically set based on location information of the mobile terminal.

The display unit 400 displays execution screens of the applications running on the mobile terminal. For example, the applications may include a messaging function, an email function, an internet access function, a multimedia function, a search function, a communication function, an electronic book function (e.g., an E-book), a video playback function, a photographing function, an image viewer function, a TV playback function (e.g., mobile broadcast such as DMB and DVB), a music player function (e.g., a Moving Picture Experts Group (MPEG)-1 or MPEG-2 Audio Layer 3 (MP3) player), and a widget management function. The display unit 400 may be implemented with any of a Liquid Crystal Display (LCD), an Organic Light Emitting Diode (OLED), and an Active Matrix OLED (AMOLED).

The display unit 400 supports a portrait mode and a landscape mode. The display unit 400 also may include a touch input unit (not illustrated). That is, the display unit 400 may be implemented with a touchscreen. The display unit 400 may be configured, when the photographing function is activated with the camera module 300, to generate the input signal in response to a user interaction and transfers the input signal to the control unit 600. The display unit 400 displays preview data obtained, from the camera module 300, after removing flicker noise.

The location information receiver 500 may include a Global Positioning System (GPS) module for acquiring the location information of the mobile terminal The location information receiver 500 may receive coordinates of the mobile terminal from a satellite and transfers the coordinates to the control unit 600. Although the mobile terminal of FIG. 1 includes the location information receiver 500, the location information receiver may be omitted in the configuration of the mobile terminal. In this case, the location information can be acquired using triangulation. For this purpose, the mobile terminal may further include an application for processing a sequence to acquire the location information based on the triangulation principle.

The control unit 600 controls general operations of the mobile terminal. When the camera module 300 is activated, the control unit 600 acquires the location information of the mobile terminal. The control unit 600 retrieves the mains power frequency corresponding to the acquired location information from the storage unit 200. The control unit 600 compares the mains power frequency corresponding to the location information with a currently-set camera scanning frequency. If the mains power frequency corresponding to the location information is identical with the current camera scanning frequency, the control unit 600 controls to display preview data without a flicker noise canceling process. Otherwise, if the mains power frequency corresponding to the location information differs from the current camera scanning frequency, the control unit 600 performs the flicker noise canceling process.

For example, if the mains power frequency mapped to the acquired location information is 50 Hz and the current camera scanning frequency is 60 Hz, screen flicker noise occurs because the mains power frequency (50 Hz) of the region where the mobile terminal is located differs from the camera scanning frequency (60 Hz). In this case, the control unit 600 adjusts the camera scanning frequency to be matched to the mains power frequency of the current location. That is, the control unit 600 may control such that, when the camera module 300 is activated, the camera scanning frequency is automatically matched to the mains power frequency of the current region based on the location information of the mobile terminal, resulting in canceling the screen flicker noise. In addition, the control unit 600 may perform other control operations related to the functions of the camera module 300 and related applications.

The control unit 600 may further include a location information generator 700 for acquiring the location information of the mobile terminal. The location information generator 700 acquires actual coordinates of the location of the mobile terminal by means of the location information receiver 500 or the triangulation technique and determines the location information of the mobile terminal based on the coordinates. The control unit 600 retrieves the mains power frequency mapped to the location information provided by the location information receiver 700 and compares the retrieved mains power frequency with the current scanning frequency. The method for controlling operations of the mobile terminal will be described below in more detail.

The control unit 600 can register the location information determined by the location information receiver 700, mapping to the mains power frequency of the corresponding region. For example, the control unit 600 can acquire the location information of the mobile terminal by means of the location information receiver 500 or the triangulation technique. The control unit 600 also can acquire the information on the mains power frequency of the regions where the mobile terminals is located through a service provided by the mobile communication carrier or a service provider. Thereafter, the control unit 600 can register the current location of the mobile terminal mapped to the acquired mains power frequency. A method for registering the current location is described below in more detail with reference to the mobile terminal operation control method.

The mobile terminal depicted in FIG. 1 may be any of a bar type device, a folder type device, a slide type device, a swing type device, a flip type device, and the like. The mobile terminal according to an exemplary embodiment of the present invention can be any of all the types of information processing devices, multimedia devices, and their equivalents. For example, the mobile terminal may be any of portable devices including the mobile communication terminals operating based on the communication protocols supported by the corresponding mobile communication systems, Portable Multimedia Players (PMPs), digital broadcast players, Personal Digital Assistants (PDAs), music players (e.g., an MP3 player), portable game consoles, and Smartphones. Also, the method for suppressing flicker noise according to an exemplary embodiment of the present invention may be applied to large and intermediate size devices such as a Television (TV), a Large Format Display (LFD), a Digital Signage (DS), a media pole, a Personal Computer (PC), and a laptop computer.

FIG. 2 is a flowchart illustrating a mains power frequency registration procedure of a flicker phenomenon suppression method for a mobile terminal according to an exemplary embodiment of the present invention.

The mobile terminal acquires location information, maps the location information to the mains power frequency, and stores the mapping between the location information and the mains power frequency. At this time, the mappings between the location information and the mains power frequencies can be provided as basic information at the manufacturing stage of the mobile terminal and can be updated according to the procedure of FIG. 2. That is, the mappings between location information and mains power frequencies can be added, deleted, and modified by a user.

Referring to FIG. 2, the control unit 600 acquires the location information of the mobile terminals at step 201. For example, the control unit 600 may acquire the current location information by means of the location information receiver 500 or the triangulation technique. After acquiring the location information, the control unit 600 acquires the information on the mains power frequency of the current region at step 203. For example, the control unit 600 accesses the mobile communication carrier server or service provider server to request for the information on the mains power frequency corresponding to the acquired location information. Here, the mobile communication carrier server or the service provider server can provide the mobile terminal with the mains power frequency information of the current region (i.e., a country). The control unit 600 may acquire the mains power frequency corresponding to the location information based on the information provided by the mobile communication carrier server or the service provider.

The control unit 600 maps the location information to the mains power frequency of the current region at step 205. For example, the control unit 600 maps the current location information of the mobile terminal to the mains power frequency of the current regions where the mobile terminal is located based on the mains power frequency information provided by the server at step 205 and updates previously saved mapping information with new mapping information at step 207. Here, the mapping information may be managed and saved in a table format as shown in Table 1.

TABLE 1

| Region information | Location information | Power frequency |
|---|---|---|
| Region A | 1^{st} to 10^{th} coordinates | 60 Hz |
| Region B | 11^{th} to 20^{th} coordinates | 50 Hz |
| Region C1 | 21^{st} to 30^{th} coordinates | 60 Hz |
| Region C2 | 31^{st} to 40^{th} coordinates | 50 Hz |

As shown in Table 1, the location information of the mobile terminal can be coordinates belonging to a geographical region (i.e., a country) and mapped to the mains power frequency of the region. For example, region A uses the mains power frequency of 60 Hz NTSC standard as Korea and the United State of America, region B uses the mains power frequency of 50 Hz PAL standard as Europe, and region C1 and C2 use the respective 60 Hz NTSC standard and 50 Hz PAL standard as Japan.

The control unit 600 automatically acquires the location information of the mobile terminal and automatically matches the scanning frequency of the camera module 300 to the mains power frequency of the external light of the current region based on the location information to prevent flicker phenomenon. For example, when the acquired location information of the mobile terminal is in the range of the 1^{st} to 10^{th} coordinates, the control unit 600 sets the scanning frequency of the camera module 300 to the mains power frequency of 60 Hz which is used in region A (e.g., Korea and the US). Also, when the acquired location information of the mobile terminal is in the range of the 11^{th} to 20^{th} coordinates, the control unit 600 sets the scanning frequency of the camera module 300 to the mains power frequency of 50 Hz which is used in region B (e.g., Europe). Also, when the acquired location information of the mobile terminal is in the range of the 21^{st} to 30^{th} coordinates, the control unit 600 sets the scanning frequency of the camera module 300 to the mains power frequency of 60 Hz which is used in region C1 (e.g., west region of Japan). Also, when the acquired location information of the mobile terminal is in the range of the 31^{st} to 40^{th} coordinates, the control unit 600 sets the scanning frequency of the camera module 300 to the mains power frequency of 50 Hz which is used in region C2 (e.g., east region of Japan). Regions A, B, C1, and C2, and the location information ranges of the 1^{st} to the 10^{th} coordinates, the 11^{st} to the 20^{th} coordinates, the 21^{st} to 30^{th} coordinates, and the 31^{st} to 40^{th} coordinates are distinguished for convenience of description. As described above, the region information (i.e., region A, region B, and Region C) can be distinguished by country, and a country can be further divided into sub-regions (i.e., the country region C is divided into regions C1 and C2).

When there is no information about the current region (e.g., region D) of the mobile terminal in the mapping table as shown in Table 1, the control unit 600 may acquire the current location information of the mobile terminal and the mains power frequency of the region to which the current location belongs and add the new mapping information to the mapping table.

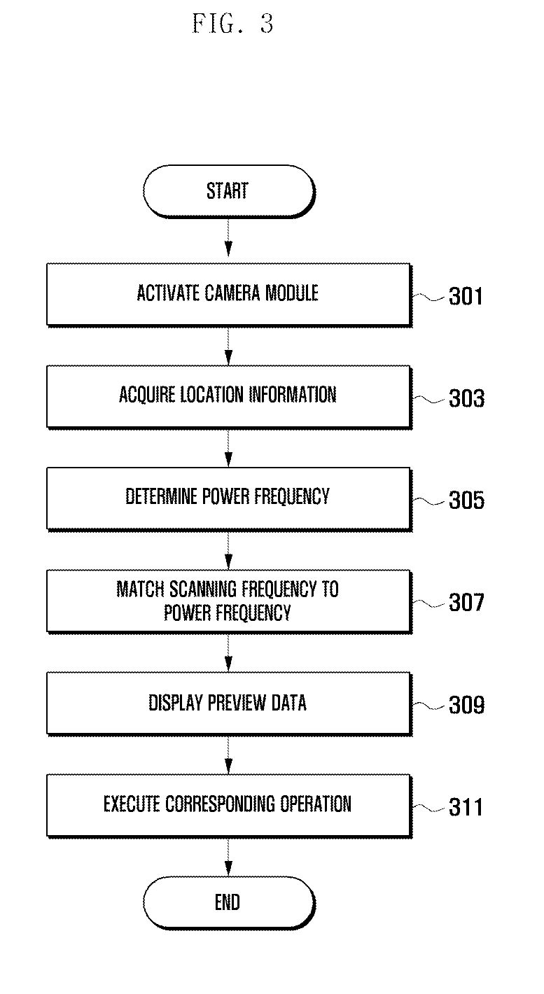

FIG. 3 is a flowchart illustrating a frequency matching procedure of a flicker phenomenon suppression method for a mobile terminal according to an exemplary embodiment of the present invention.

Referring to FIG. 3, the control unit 600 activates the camera module 300 at step 301. For example, the control unit 600 receives the signal input by means of the input unit 100 or the display unit 400 and controls power supply to the camera module 300 in response to the input signal. If the camera module 300 is activated, the control unit 600 can acquire the location information of the mobile terminal at step 303.

The control unit 600 determines the mains power frequency of the region to which the current location belongs at step 305. For example, after acquiring the location information, the control unit 600 searches the mapping table (e.g., Table 1) for the location information and retrieves the mains power frequency mapped to the location information.

Once the mains power frequency of the current region is acquired, the control unit 600 matches the camera scanning frequency of the camera module 300 to the mains power frequency of the current region at step 307. For example, if the mains power frequency of the current region is 50 Hz, the control unit 600 matches the scanning frequency of the camera module 300 to the mains power frequency value of 50 Hz.

The control unit 600 controls such that the preview data captured by the camera module 300 is displayed on the display unit 400 at step 309. Thereafter, the control unit 600 controls such that the camera module 300 takes a picture in response to a user input signal at step 311.

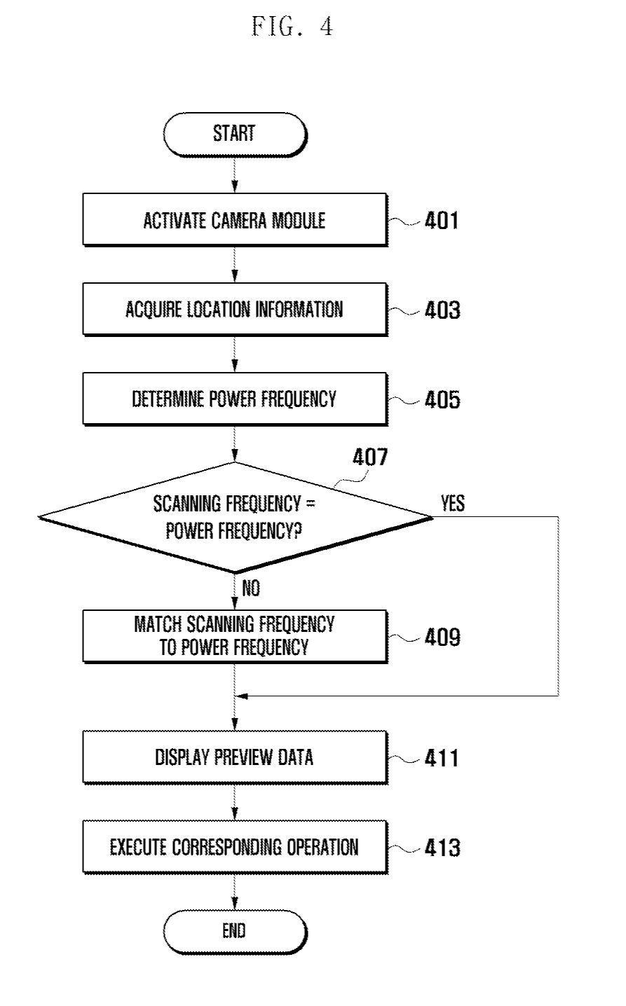

FIG. 4 is a flowchart illustrating a frequency matching procedure of a flicker phenomenon suppression method for a mobile terminal according to an exemplary embodiment of the present invention.

Referring to FIG. 4, the control unit 600 activates the camera module 300 and controls operations of the camera module 300 at step 401. Upon activation of the camera module 300, the control unit 600 acquires the location information of the mobile terminal at step 403.

The control unit 600 determines the mains power frequency corresponding to the acquired location information at step 405. For example, the control unit 600 looks up the mapping table (i.e., Table 1) to retrieve the mains power frequency mapped to the location information.

Once the mains power frequency is retrieved, the control unit 600 compares the mains power frequency mapped to the location information with the current scanning frequency of the camera module 300 at step 407. If the mains power frequency mapped to the location information is identical with the current scanning frequency of the camera module 300, the control unit 600 controls such that the preview data captured by the camera module 300 is displayed on the display unit 400 at step 411. Thereafter, the control unit 600 controls such that the camera module 300 takes a picture in response to a user input signal at step 413.

If the mains power frequency mapped to the location information differs from the current scanning frequency of the camera module 300 at step 407, the control unit 600 matches the scanning frequency of the camera module 300 to the mains power frequency of the current region based on the location information at step 409. For example, if the mains power frequency mapped to the location information is 50 Hz and the scanning frequency of the camera module 300 is 60 Hz, the control unit 600 changes the scanning frequency of the camera module 300 from 60 Hz to 50 Hz to be matched to the mains power frequency.

The control unit 600 controls such that the preview data captured by the camera module 300 is displayed on the display unit 400 at step 411. Thereafter, the control unit 600 controls such that the camera module 300 takes a picture in response to a user input signal at step 413.

As described above, the flick phenomenon suppression method of the exemplary embodiments of the present invention can be implemented in the form of program commands and can be recorded in a computer-readable storage medium. The computer-readable storage medium can store any or a combination of programs commands, data files, and data structure. The program commands recorded in the storage medium can be designed and structured according to the exemplary embodiments of the present invention, but may be well-known to and practiced by those skilled in the art.

The computer-readable storage medium can be any of magnetic media including a hard disk, a floppy disk, magnetic tape, and the like, optical media including a Compact Disc Read Only Memory (CD-ROM), a Digital Versatile Disc (DVD), and the like, magneto-Optical Media including a Floptical Disk, a Read Only Memory (ROM), a Random Access Memory (RAM), a Flash memory, and the like that can be configured to store the program commands. The program commands include high-level language codes that can be executable in the computer with the interpreter as well as machine language code produced by a complier. The hardware device can be configured to operate in the form of more than one software module for performing the operation of the present invention and vice versa.

As described above, a flicker phenomenon suppression method and apparatus of the exemplary embodiments of the present invention are capable of automatically matching the scanning frequency of a camera module of a mobile terminal to a mains power frequency of a region where the mobile terminal is located, resulting in preventing the flicker phenomenon. The flicker phenomenon suppression method and apparatus of the exemplary embodiments of the present invention automatically acquire location information, when the camera module of the mobile terminal is activated, and automatically matches a scanning frequency of the camera module to the mains frequency region identified based on the location information, resulting in suppressing flicker noise on the screen. Accordingly, the camera module of the mobile terminal can operate always in an optimum photographing environment. The flicker phenomenon suppression method and apparatus of the exemplary embodiments of the present invention prevents the need of manually changing the scanning power of the camera module, resulting in improvement of device usability, user convenience, and product competitiveness.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for suppressing screen flicker phenomenon in a mobile terminal, the method comprising:
acquiring, when a camera module of the mobile terminal is activated, location information of the mobile terminal;
determining power frequency mapped to the location information; and
matching a scanning frequency of the camera module to the power frequency.

2. The method of claim 1, wherein the location information is acquired by Global Positioning System (GPS) coordinates of a location of the mobile terminal or a triangulation coordinates technique, and the power frequency is acquired by a mobile communication carrier server or a service provider server.

3. The method of claim 1, wherein the determining of the power frequency comprises:
looking up a mapping table for the location information; and
retrieving the power frequency mapped to the location information.

4. The method of claim 3, further comprising displaying preview data captured by the camera module after matching the scanning frequency of the camera module to the power frequency.

5. The method of claim 3, wherein the matching of the scanning frequency comprises comparing the scanning frequency of the camera module with the power frequency.

6. The method of claim 5, wherein the matching of the scanning frequency comprises:
displaying, when the scanning frequency is identical to the power frequency, preview data captured by the camera module; and
matching, when the scanning frequency differs from the power frequency, the scanning frequency to the power frequency.

7. The method of claim 5, further comprising updating the mapping table, wherein the mapping table comprises power frequencies mapped to the location information.

8. The method of claim 7, wherein the updating of the mapping table comprises:
acquiring current location information of the mobile terminal;
acquiring the power frequency mapped to the current location; and
registering the current location information and the power frequency, as being mapped, with the mapping table.

9. The method of claim 8, wherein the acquiring of the power frequency comprises:
accessing a server;
requesting the server for the power frequency of a region where the mobile terminal is located; and
receiving information on the power frequency of the region from the server.

10. A mobile terminal comprising:
a camera module for taking a picture;
a display unit for displaying preview data input through the camera module;
a location information generator for acquiring location information of the mobile terminal;
a storage unit for storing a mapping table including mapping information between location information and power frequencies; and
a control unit for acquiring current location information when the camera module is activated and for matching a scanning frequency of the camera module to a power frequency mapped to the current location information.

11. The mobile terminal of claim 10, wherein the location information generator acquires location information by Global Positioning System (GPS) coordinates of a location of the mobile terminal or a triangulation coordinates technique, and the power frequencies are acquired by a mobile communication carrier server or a service provider server.

12. The mobile terminal of claim 10, wherein the control unit compares the scanning frequency of the camera module with the power frequency.

13. The mobile terminal of claim 12, wherein the control unit displays, when the scanning frequency is identical to the power frequency, the display data from the camera module, and matches, when the scanning frequency differs from the power frequency, the scanning frequency to the power frequency.

14. The mobile terminal of claim 10, further comprising a location information receiver for receiving coordinates of the mobile terminal from a satellite.

15. The mobile terminal of claim 10, wherein the mapping table comprises default mapping information and is updated according to a user's intention.

16. The mobile terminal of claim 15, wherein the control unit acquires current location information of the mobile terminal and the power frequency mapped to the current location and updates the mapping table with the current location information and the power frequency.

17. The mobile terminal of claim 16, wherein the control unit controls the mobile terminal to access a server, requests the server for the power frequency of a region where the mobile terminal is located, and receives information on the power frequency of the region from the server.
